(19) United States
(12) Patent Application Publication
(10) Pub. No.: US 2013/0346571 A1
(43) Pub. Date: Dec. 26, 2013

(54) Computer and method of operation of its network

(71) Applicants: Mikalai Putseyeu, Vitebsk (BY); Uladzimir Putseyeu, Vitebsk (BY); Pavel Makaveev, Toronto (CA)

(72) Inventors: Mikalai Putseyeu, Vitebsk (BY); Uladzimir Putseyeu, Vitebsk (BY); Pavel Makaveev, Toronto (CA)

(73) Assignee: sergei makaveev, Toronto, ON (CA)

(21) Appl. No.: 13/531,573

(22) Filed: Jun. 24, 2012

(51) Int. Cl. H04L 12/24

(52) U.S. Cl. CPC H04L 41/00
USPC 709/223

(57) ABSTRACT

The computer is divided into blocks of storage which processing and display of the information and the receptions of commands from independently working in a network. Preinstalled operational system allows entering a network and choosing the necessary software to operate. It is not required software distributions on physical carriers, purchases through networks etc. with installation on the user computers. Pirate copying and distribution of programs, for example operating systems, becomes impossible, and updating is unnecessary.

Mobile computers will have a capability to function as the stationary computer, and also will have extended resources at its disposal because expend processing power will be a stationary unit.

The greatest effect will be using high-speed access to a network, with rent of programs and with protection from interference. Thus, user will only need knowledge of a basic computer operation and software use, rather than its installation that expands access to the computer.

### AREA WHICH THE INVENTION CONCERNS

Aspects of the invention concern devices of the personal computer, its software, its interaction with a network and the software accessible through a network. System “Computer—Software—Network” is improved so that to expand access to software, thus to simplify the computer, as well as to increase protection against unauthorized interference, thereby increasing the capabilities of a computer and convenience of its usage.

### PRIOR LEVEL OF TECHNICS

Computer systems with an operational system are usually uses input/output devices, storing and processing data, network connection, as well as preinstalled software on it so that when working with the network upgrade software, process of exchange and store the information.

For example, the cloud service of Google is provided by such principle.

Also available access through a network to software.

In patents and requests U.S. Pat. No. 7,024,427 (B2) Virtual file system EMC CORP Apr. 4, 2006;

U.S. Pat. No. 6,922,813 (B1) Page prerequisite control mechanism TRADE E Jul. 26, 2005;

U.S. Pat. No. 6,185,733 (B1) Method and apparatus for remote object code inclusion IBM Feb. 6, 2001;

U.S. Pat. No. 5,809,329 (A) System for managing the configuration of a computer system MICROSOFT CORP Sep. 15, 1998;

U.S. Pat. No. 5,778,226 (A) Kernels, description tables and device drivers IOMEGA CORP Jul. 7, 1998;

U.S. Pat. No. 4,974,151 (A) Configuration capability for devices in an open system having the capability of adding or changing devices by user commands IBM Nov. 27, 1990;

US 2003046682 (A1) System and method for the automatic installation and configuration of an operating system IBM Mar. 6, 2003;

US 2003023603 (A1) Database server with enhanced management and self-configuration features ELLISON LAWRENCE J. Jan. 30, 2003;

US 2003009754 (A1) Installing supervisory process control and manufacturing software from a remote location and maintaining configuration data links in a run-time environment WONDERWARE CORP Jan. 9, 2003;

US 2002178233 (A1) Method and apparatus for the automatic migration of applications and their associated data and configuration files IBM Nov. 28, 2002;

US 2002112232 (A1) System and process for building host computers REAM JAMES A. Aug. 15, 2002 and U.S. Pat. No. 6,801,937 (B1) Method, system and program products for defining nodes to a cluster IBM Oct. 5, 2004;

U.S. Pat. No. 6,289,382 (B1) System, method and article of manufacture for a globally addressable interface in a communication services patterns environment ANDERSEN CONSULTING LLP Sep. 11, 2001;

U.S. Pat. No. 6,202,149 (B1) Automated application fail-over for coordinating applications with DBMS availability NCR CORP Mar. 13, 2001;

U.S. Pat. No. 6,173,420 (B1) Method and apparatus for fail safe configuration ORACLE CORP Jan. 9, 2001;

US 2005267951 (A1) Rolling upgrade of distributed software with automatic completion ORACLE INT CORP Dec. 1, 2005;

US 2005234680 (A1) Simplified and optimized process for application user interface testing and validation IBM Oct. 20, 2005;

US 2004139145 (A1) Method and apparatus for scalable distributed storage BAR-OR GIGY Jul. 15, 2004 are offered a various variants of setting and software update on the personal computer.

Patent U.S. Pat. No. 7,698,391 Paliwal, et al. Apr. 13, 2010 performing a provisioning operation associated with a software application on a subset of the nodes on which the software application is operate to. Application deployment architecture provides the capability to independently invoke different phases of an operation associated with an application, thereby progressively deploying the application across a network of peer nodes and providing fault tolerance. Therefore, applications are easier to deploy on the network of nodes, the deployment process is less error prone, and remediation of deployment errors is simpler than with prior approaches. Tasks constituent to phases of a deployment process are schedulable rather than completely automated and outside the control of the administrator, and are schedulable on a subset of the nodes rather than only on the entire network of nodes.

U.S. Pat. No. 7,340,739 Alam Mar. 4, 2008 Automatic configuration of a server offers a computer system and program product for building a server according to specifications. There are multiplicities of program objects to install a respective multiplicity of programs on the server. First program instructions determine a plurality of the program objects which currently have prerequisite software and parameters for their respective applications. Second program instructions concurrently invoke the plurality of program objects. At least one of the pluralities of program objects, after execution, invokes another of the program objects, supplying a prerequisite parameter for the other program object.

In a U.S. Pat. No. 7,971,187 (B2) Configurable software stack MICROSOFT CORP Jun. 28, 2011; U.S. Pat. No. 7,873,940 (B2) Providing packages for configuring software stacks MICROSOFT CORP Jan. 18, 2011 is also developing a proposal for improving “Computer-Software-Network” system.

The specified application and patents disclose composition and functioning of a computer in a network, but are reduced to working in a network on a computer with the installed operating system and software, requiring periodic update. Also, specified patent does not taken into account that the computer's software and its data during independent work with a network is subject to unauthorized access and damage.

Accordingly, there is a need for the computer functioning in a network, having mobility, high resources and long period of operation without recharge and using the software that does not require installation and update as well as easy to use and well protected.

### ESSENCE OF THE INVENTION

The offered computer has been executed as an independent physical device blocks for input, output, storing and processing of a data, network, as well as some pre-installed software such as BIOS and and programs on access to the network. Computer blocks can be made stationary or mobile, but each of them has possibility to connect and work in a network, such as the Internet. Blocks can be combined in any combination, providing the opportunity to interact, both directly and through a network.

Number of units and combinations in the computer can be any.

In one of the mobile options users can carry only device for receiving and displaying information which can be owned or rented for storing blocks and data processing through a network. This will allow to accomplish energy-intensive procedure in stationary blocks of storing and processing data, which will reduce weight, size and power consumption of the mobile unit.

The method of operation can be following. After switching ON power supply, computer is connecting to a network, such as Internet. Connection is possible to perform both with the choice of a browser, and with pre-browser, or otherwise. At the same time computer is equipped with password access, implemented, for example, connecting to a flash card with a password distributed by the owner of a rights to software, network, etc., or user's password registered with the owner of rights of software, or in the preinstalled in a computer by manufacturer. Next, user gets access to the required software and resources to work with a data.

Thus, computer has preinstalled software that allows only access network and selects necessary software to operate. Preinstalled software is executed, for example, without opportunity to reprogramming.

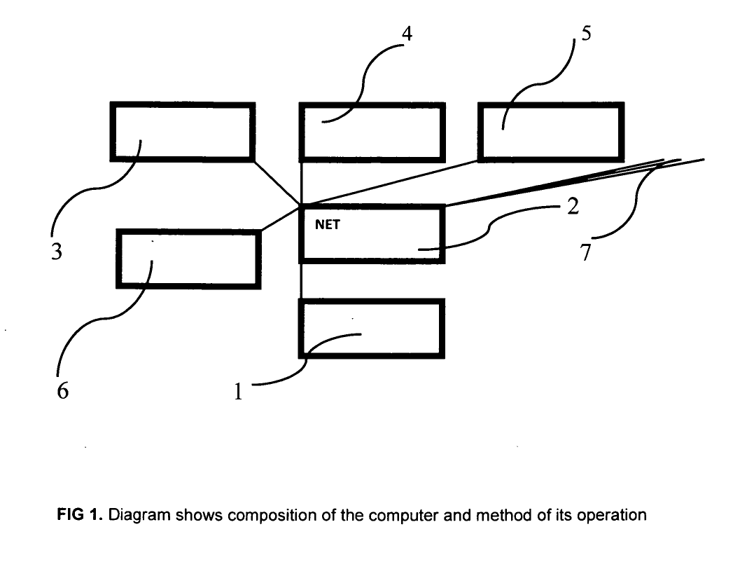

FIG. 1. Mobile block of input and display of information 1 connected through a network 2 own memory block 3 and processing block 4. Also work through a network with the software producer 5, application 6 and various services 7 to work with data.

There are can be multiple numbers of Mobile units 1 and they can be used with a phone.

Specified method does not require distributing software to physical carriers, purchases through network, etc. and installing it users' computers. Pirate copying and distribution of programs such as operating systems becomes impossible. Also becomes unnecessary to update programs since it will make the owner of software.

Also, there is a capability not to release mobile computers with high computing power, but to provide these capabilities to users through network, thus saving the Earth's resources.

When using this method with a tablet, it will have capabilities that are disposal of stationary PC which far exceeds the capabilities of Tablet with installed operating system and applications.

The greatest effect will be using in the computer devices with high-speed access to a network, with the possibility to rent programs, with protection from interference. Thus user will need only knowledge of using computer and software, rather than its installation, expanding people's access to a computer.

Also in the claimed computer as one of the components, such as data display, send and receive commands over mobile phone, such as cell phone, satellite phone or others. When using the mobile phone as an access to your own computer user experience is greatly enhanced.

To display information, send and receive commands perhaps can be use any device that can exchange commands, some data with the user, and with capability to access network. Such configuration is very convenient for transport vehicles of any purpose. For example, for tanks, a sea vessel for which it is important not to locate the executive programs and devices in the machine. This configuration is very convenient for transport vehicles of any purpose. For example for the tanks, marine vessel, for which it is important not to have at a disposal, machines executive programs and devices.

For user convenience, a computer can be made with the mode of operation option of the software. As well as a mode with installation on it operational and application software, and program usage mode from the network by users will.

The proposed method of computer operation in the network allows to fight nst pirate distribution of programs. By using this method user's computer only gets access to services of the operating system, but is unable to install it on its computer. Also it only gets access to specific programs. Thus, arise the opportunity to provide service to operate an operating system without its distribution and only to legally made and sold devices. As the operating system cannot be given borrowed, appears possibility to supervise validity of actions of the user. Service can be provided for example after confirmation of legality of access. Commands such as copying, installation and change of used programs can be blocked. For convenience of the user, storage device, manipulation, display and input of information in offered method can work and share data with each other and network, both directly and through a network. Thus, proposed method is very topical for closed networks such as banks, government institutions, etc.

In proposed method, limited software of a displaying device and input of information, such as mobile phone, applies operating system and the physical components of the computer in network. So you can use low-power computer devices to perform bulk task.

To prevent from pirate intrusion, use of software service should be provided to physical or password programmed access.

Thus, password can be distributed to the owner of the rights on software product.

To speed up the legal access, password can distribute by the owner of the rights to the software in the form of a physical device, such as flash cards.

Password can distribute by the owner of the rights to the software in the form of a physical device, such as flash cards with unchangeable code. It will help to monitor access to software and if necessary shut it down.

If password is distributed by owner of software in the form of program, it will speed up and extend access.

Password can be legally distributed at computers manufacture or its components as a program, physical device or its parts, which will strengthen sales network.

For the convenience of the user, after binding password to a computer, method provides that after switching computer from hibernation mode it will automatically start-up PC on its own exiting to its original, before using the hibernation mode, state. This allows without loss of time to continue to work in the application after the break.

According to provided method, there is possibility to create a zone with unlimited access to a product.

According to the proposed method, is possible to release physical components of the computer and preinstalled software such as it allows only rent the software, including operating systems, through the network. This measure would limit the spread of unwanted devices in certain areas.

Also, proposed method is capable to release the physical components of the computer and preinstalled software such as to allow only to install a software, including operating systems, network or otherwise. It is necessary in case of need for self-sufficiency of the computer.

The method provides also possibility to combine software installation options.

1. PCs, including physical (Hardware) device for input, output, storing, processing, network devices, with pre-installed software, with additional physical devices in computer in the form of independent devices, stationary or mobile, which is also able to connect to network and operate in it, as well as interact with each other directly or through the network, while in any combination and any number of devices.

2. Computer in claim 1, according to which one of the computer's devices, such as displaying information and receive commands using mobile phone, for example cellular, satellite or another.

3. Computer in claim 1, according to which one of the computer's devices, such as displaying information and receive commands using any device, exchanging commands and information with a user and is able to access network.

4. Computer in claim 1, according to which computer is configured to select the mode with installed software on it, as well as to use the programs from the network by user's will.

5. Method of functioning of the computer in a network, including obtaining in a network of permission to use a software, without an additional operating system and application programs on a PC, thus service is provided, for example, after acknowledgement of legality of access, during which copy commands, installations and modifications in a used programs are blocked, but storing, processing and display devices are still communicating among each other and a network, both directly and through a network.

6. Method in claim 5, with additional software for a device to display and input data, such as mobile phone uses the capabilities of operating system and physical devices of a computer on network.

7. Methods in claims 5 and 6, in which access to a program provided with additional programs by physical or programmed password.

8. Method in claim 7, according to which password is distributed by the owner of the rights of a software.

9. Method in claim 7 according to which password is distributed by the owner of the rights of a software in form of physical devices, for example, flash cards.

10. Method in claim 7, according to which password is distributed by the owner of the rights of a software in form of physical devices, for example, flash with unmodifiable code.

11. Method in claim 7, according to which password is distributed by the owner of a software in the form of a program.

12. Method in claim 7, according to which password is distributed by the computer manufacturer or its components as a program, physical device or its part.

13. Method in claim 7, according to which after switching OFF hibernation mode, computer automatically proceed to its original task before hibernating.

14. Method in clams 5 and 6, according to which access is unrestricted.

15. Method in claim 5, according to which physical devices of a computer and preinstalled operational system allows only to rent software, including operating systems on the network.

16. Method in claim 5, according to which physical devices of a computer and preinstalled operational system allows only to install a software, including operating systems, through a network or otherwise.

17. Method in claim 5, according which can be combined according to claims 15 and 16.
